(19) United States
(12) Patent Application Publication
(10) Pub. No.: US 2022/0009516 A1
(43) Pub. Date: Jan. 13, 2022

(54) VEHICLE TRAVEL CONTROL DEVICE

(71) Applicant: Mazda Motor Corporation, Hiroshima (JP)

(72) Inventors: Shinsuke SAKASHITA, Aki-gun (JP); Daisuke HORIGOME, Aki-gun (JP); Masato ISHIBASHI, Aki-gun (JP); Eiichi HOJIN, Aki-gun (JP)

(73) Assignee: Mazda Motor Corporation, Hiroshima (JP)

(21) Appl. No.: 17/486,957

(22) Filed: Sep. 28, 2021

Related U.S. Application Data
(63) Continuation of application No. PCT/JP2020/009954, filed on Mar. 9, 2020.

(30) Foreign Application Priority Data
Mar. 29, 2019 (JP) 2019-066769

(51) Int. Cl. B60W 50/14; B60W 30/14; B60R 1/00; G06K 9/00

(52) U.S. Cl. CPC B60W 50/14; B60W 30/14; B60R 1/00; B60W 2050/0028; B60R 2300/304; B60W 2420/42; B60W 2050/146; G06K 9/00805

(57) ABSTRACT

A vehicle cruise control device includes: an arithmetic circuitry and a device circuitry that controls actuation of traveling devices mounted in a vehicle. The arithmetic circuitry is configured to recognize a vehicle external environment; set a route to be traveled by the vehicle; determine a target motion of the vehicle to follow the set route; and generate an image to be displayed for driving assistance, by using an image taken by the camera and information on the recognized vehicle external environment. The control circuitry is configured to control actuation of one or more traveling devices mounted in the vehicle, based on the target motion determined.

### CROSS-REFERENCE TO RELATED APPLICATIONS

The present application claims priority to international application PCT/JP2020/009954, filed Mar. 9, 2020, and Japanese application number 2019-066769 filed in the Japanese Patent Office on Mar. 29, 2019, the entire contents of both of which being incorporated herein by reference.

### TECHNICAL FIELD

The present disclosure belongs to a technical field related to a vehicle cruise control device.

### BACKGROUND

There has been a known vehicle cruise control device which controls a plurality of vehicle-mounted units for traveling, which are mounted in a vehicle.

For example, Patent Document 1 discloses, as a vehicle cruise control device, a control system including unit controllers controlling the respective on-board units, a domain controller controlling the unit controllers as a whole, and an integrated controller controlling the domain controllers as a whole. The control system is divided into a plurality of domains corresponding to the respective functions of the vehicle-mounted units in advance. Each of the domains is stratified into a group of the unit controllers and the domain controller. The integrated controller dominates the domain controllers.

In Patent Document 1, the unit controllers each calculate a controlled variable of an associated one of the vehicle mounted units, and each output a control signal for achieving the controlled variable to the associated vehicle-mounted unit.

### CITATION LIST

### Patent Document

Patent Document 1: Japanese Unexamined Patent Publication No. 2017-61278

### SUMMARY OF TECHNICAL PROBLEMS

In recent years, development of autonomous driving systems has been promoted. In general, in an autonomous driving system, a camera, for example, acquires the information on the environment outside a vehicle, and the route to be traveled by the vehicle is calculated based on the acquired information on the vehicle external environment. Further, in the autonomous driving system, traveling devices are controlled to follow the route to be traveled.

In addition, there are an increasing number of vehicles provided with an HMI (Human Machine Interface) unit for driving assistance. For example, the HMI unit combines images taken by cameras provided to a vehicle body to generate an image showing the status around the vehicle, and displays the image on a display. This allows a driver to instantly recognize the circumstance around the vehicle by looking at the image displayed on the display. Typically, control of the traveling devices along a calculated route in an autonomous driving system and the HMI unit are not separate from each other, because doing so will result in an intricate configuration, an increase in costs, and intricate configuration for transmitting data output from the cameras.

The technology disclosed in the present disclosure was made in view of the above-described point, and one aspect of the present disclosure is to enable displaying of an image for driving assistance with a simple configuration in a vehicle cruise control device that controls actuation of traveling devices so as to follow a calculated route.

### SUMMARY

To achieve the one or more aspects, a herein-disclosed vehicle cruise control device that controls traveling of a vehicle includes an arithmetic unit; and a device controller that controls actuation of one or more traveling devices mounted in the vehicle, based on an arithmetic result from the arithmetic unit. The arithmetic unit includes: a vehicle external environment recognition unit that recognizes a vehicle external environment based on an output from a camera provided to the vehicle and takes an image of the vehicle external environment; a route setting unit that sets a route to be traveled by the vehicle, in accordance with the vehicle external environment recognized by the vehicle external environment recognition unit; a target motion determination unit that determines a target motion of the vehicle to follow the route set by the route setting unit; and a drive-assisting image generation unit that generates an image to be displayed for driving assistance, by using an image taken by the camera and information on the vehicle external environment recognized by the vehicle external environment recognition unit.

In this configuration, the arithmetic unit includes the drive-assisting image generation unit that generates an image to be displayed for driving assistance, in addition to the function of executing calculation for actuating the one or more traveling devices mounted in the vehicle. With this configuration, the HMI unit itself does not have to generate an image for driving assistance by taking in an enormous amount of raw data such as camera images. Therefore, it is possible to display an image that assists the driver without providing a large-scale HMI unit, in addition to the arithmetic unit. Even if an HMI unit is provided to the vehicle, that HMI unit does not have to have a function to generate an image for driving assistance from an enormous amount of raw data such as camera images. In addition, since outputs from the camera whose data volume is large simply has to be transmitted to the arithmetic unit, the configuration for data transmission in the vehicle is simplified.

The vehicle cruise control device may be such that the drive-assisting image generation unit receives information on an obstacle from the vehicle external environment recognition unit, generates an image showing a region around the vehicle including the vehicle by combining images taken by the camera, and superimposes an indication that emphasizes the obstacle on the image generated.

With this configuration, the arithmetic unit is able to generate an image showing the region around the vehicle, with an obstacle emphasized.

The vehicle cruise control device may be such that the arithmetic unit further includes a physical amount calculation unit that calculates target physical amounts to be generated by the one or more traveling devices, in order to achieve the target motion determined by the target motion determination unit, and the device controller calculates controlled variables of the one or more traveling devices to achieve the target physical amounts calculated by the physical amount calculation unit, and outputs control signals to the one or more traveling devices.

With this configuration, the arithmetic unit only calculates the physical amounts that should be achieved, and the actual controlled variables of the traveling devices are calculated by the device controller. This reduces the amount of calculation by the arithmetic unit, and improves the speed of calculation by the arithmetic unit. In addition, since the device controller simply has to calculate the actual controlled variables and output control signals to the associated traveling devices, the processing speed is increased. As a result, the responsiveness of the traveling devices to the vehicle external environment can be improved.

In addition, by having the device controller calculate the controlled variables, the calculation speed of the arithmetic unit can be slower than that of the device controller, because the arithmetic unit only needs to roughly calculate physical amounts. Thus, the accuracy of calculation by the arithmetic unit is improved.

In addition, by having the device controller calculate the controlled variables, a small change in the vehicle external environment can be coped without involving the arithmetic unit, by having the device controller adjust the controlled variables.

In an arithmetic unit of the above-described vehicle cruise control device, the vehicle external environment recognition unit may be configured so as to recognize the vehicle external environment by means of deep learning.

In this configuration in which the vehicle external environment recognition unit recognizes the vehicle external environment by means of deep learning, the amount of calculation by the arithmetic unit is significantly increased. By having the controlled variables of the traveling devices calculated by the device controller, which is separate from the arithmetic unit, it is possible to more appropriately exert the effect of further improving the responsiveness of the traveling devices with respect to the vehicle external environment.

### Advantages

As can be seen from the description herein, the technology disclosed in the present disclosure enables displaying of an image for driving assistance with a simple configuration in a vehicle cruise control device that controls actuation of traveling devices so as to follow a route calculated by an arithmetic unit.

### BRIEF DESCRIPTION OF THE DRAWINGS

FIG. 1 schematically shows a configuration of a vehicle that is controlled by a vehicle cruise control device according to an exemplary embodiment.

FIG. 2 is a schematic view illustrating a configuration of an engine.

FIG. 3 is a block diagram showing a control system of a motor vehicle.

FIG. 4 is an exemplary configuration of an arithmetic unit.

FIG. 5 is an example of an image for driving assistance.

FIG. 6 is a diagram of computer (including circuitry) and a network architecture of an arithmetic unit according to the embodiments

FIG. 7 is a diagram of an AI-based computer architecture according to an embodiment.

FIG. 8 is a diagram of a data extraction network according to an embodiment.

FIG. 9 is a diagram of a data analysis network according to an embodiment.

FIG. 10 is a diagram of a concatenated source feature map according to an embodiment.

### DETAILED DESCRIPTION

Exemplary embodiments will now be described in detail with reference to the drawings. Note that “devices” such as “traveling devices” of the present disclosure indicate devices such as actuators and sensors mounted in a vehicle.

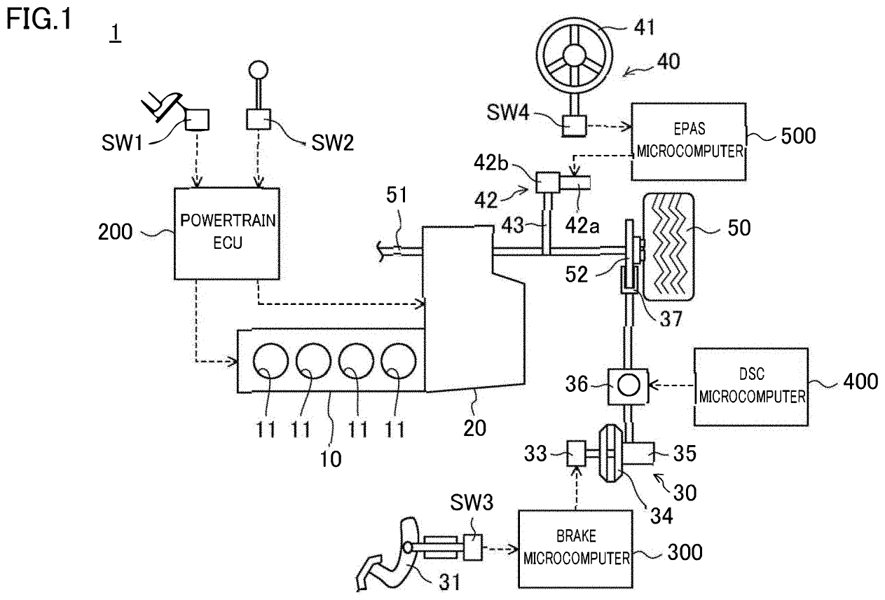

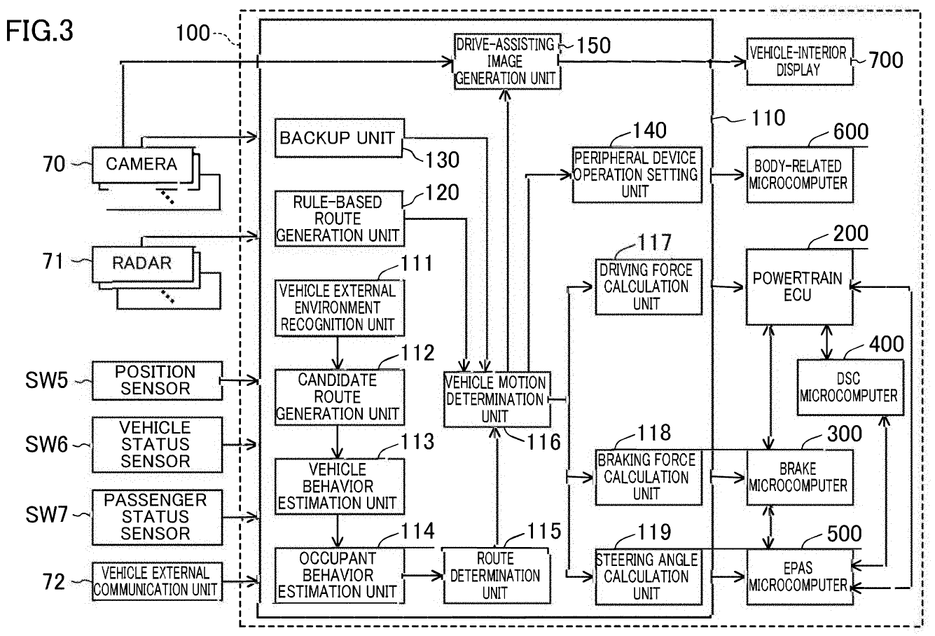

FIG. 1 schematically shows a configuration of a vehicle 1 which is controlled by a vehicle cruise control device (hereinafter simply referred to as a “cruise control device 100” shown in FIG. 3) 100 according to the present embodiment. The vehicle 1 is a motor vehicle that allows manual driving in which the vehicle 1 travels in accordance with an operation of an accelerator and the like by a driver, assist driving in which the vehicle 1 travels while assisting an operation by the driver, and autonomous driving in which the vehicle 1 travels without an operation by the driver.

The vehicle 1 includes an engine 10, e.g., an internal combustion engine, as a drive source having a plurality of (four in the present embodiment) cylinders 11, a transmission 20 coupled to the engine 10, a brake device 30 that brakes rotation of front wheels 50 serving as driving wheels, and a steering device 40 that steers the front wheels 50 serving as steered wheels. Alternatively, the engine 10 may be an electrical engine that may be directly controlled.

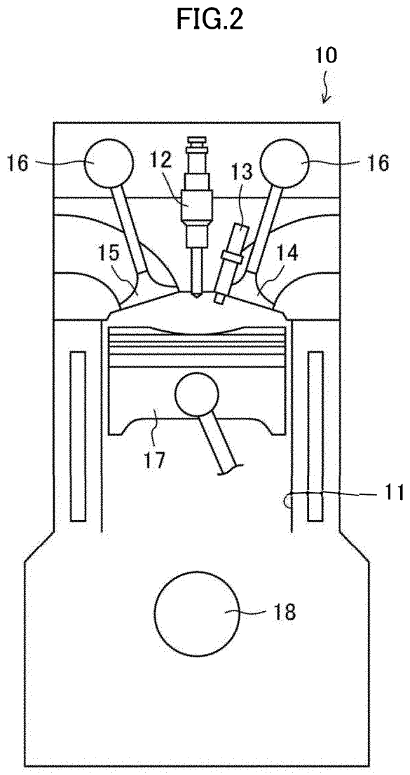

The engine 10 may be, e.g., a gasoline engine. As shown in FIG. 2, each cylinder 11 of the engine 10 includes an injector 12 for supplying fuel into the cylinder 11 and a spark plug 13 for igniting an air-fuel mixture of the fuel and intake air supplied into the cylinder 11. In addition, the engine 10 includes, for each cylinder 11, an intake valve 14, an exhaust valve 15, and a valve train mechanism 16 that adjusts opening and closing operations of the intake valve 14 and the exhaust valve 15. In addition, the engine 10 is provided with pistons 17 each reciprocates in the corresponding cylinder 11 and a crankshaft 18 connected to the pistons 17 via connecting rods. Alternatively, the engine 10 may be a diesel engine. In a case of adopting a diesel engine as the engine 10, the spark plug 13 does not have to be provided. The injector 12, the spark plug 13, and the valve train mechanism 16 are examples of devices related to a powertrain.

The transmission 20 (for internal combustion engines) is, for example, a stepped automatic transmission. The transmission 20 is arranged on one side of the engine 10 along the cylinder bank. The transmission 20 includes an input shaft coupled to the crankshaft 18 of the engine 10, and an output shaft coupled to the input via a plurality of reduction gears. The output shaft is connected to an axle 51 of the front wheels 50. The rotation of the crankshaft 18 is changed by the transmission 20 and transmitted to the front wheels 50. The transmission 20 is an example of the devices related to the powertrain.

The engine 10 and the transmission 20 are powertrain devices that generate a driving force for causing the vehicle 1 to travel. The operations of the engine 10 and the transmission 20 are controlled by a powertrain electric control unit (ECU) 200. For example, during the manual driving of the vehicle 1, the powertrain ECU 200 controls a fuel injection amount from and a timing for fuel injection by the injector 12, a timing for ignition by the spark plug 13, timings for opening the intake and exhaust valves 14 and 15 by the valve train mechanism 16, and the duration of opening these valves, based on values such as a detected value of an accelerator position sensor SW1 that detects an accelerator position and the like, which correspond to an operation amount of the accelerator pedal by the driver. In addition, during the manual driving of the vehicle 1, the powertrain ECU 200 adjusts the gear position of the transmission 20 based on a required driving force calculated from a detection result of a shift sensor SW2 that detects an operation of the shift lever by the driver and the accelerator position. In addition, during the assist driving or the autonomous driving of the vehicle 1, the powertrain ECU 200 basically calculates a controlled variable for each traveling device (injector 12 and the like in this case) and outputs a control signal to the corresponding traveling device, so as to achieve a target driving force calculated by an arithmetic unit 110 described hereinafter. The powertrain ECU 200 is an example of device controllers.

The brake device 30 includes a brake pedal 31, a brake actuator 33, a booster 34 connected to the brake actuator 33, a master cylinder 35 connected to the booster 34, dynamic stability control (DSC) devices 36 that adjust the braking force, and brake pads 37 that actually brake the rotation of the front wheels 50. To the axle 51 of the front wheels 50, disc rotors 52 are provided. The brake device 30 is an electric brake, and actuates the brake actuator 33 in accordance with the operation amount of the brake pedal 31 detected by the brake sensor SW3, to actuate the brake pads 37 via the booster 34 and the master cylinder 35. The brake device 30 cramps the disc rotor 52 by the brake pads 37, to brake the rotation of each front wheel 50 by the frictional force generated between the brake pads 37 and the disc rotor 52. The brake actuator 33 and the DSC device 36 are examples of devices related to the brake.

The actuation of the brake device 30 is controlled by a brake microcomputer 300 and a DSC microcomputer 400. For example, during the manual driving of the vehicle 1, the brake microcomputer 300 controls the operation amount of the brake actuator 33 based on a detected value from the brake sensor SW3 that detects the operation amount of the brake pedal 31 by the driver, and the like. In addition, the DSC microcomputer 400 controls actuation of the DSC device 36 to add a braking force to the front wheels 50, irrespective of an operation of the brake pedal 31 by the driver. In addition, during the assist driving or the autonomous driving of the vehicle 1, the brake microcomputer 300 basically calculates a controlled variable for each traveling device (brake actuator 33 in this case) and outputs a control signal to the corresponding traveling device, so as to achieve a target braking force calculated by the arithmetic unit 110 described hereinafter. The brake microcomputer 300 and the DSC microcomputer 400 are examples of the device controllers. Note that the brake microcomputer 300 and the DSC microcomputer 400 may be configured by a single microcomputer.

The steering device 40 includes a steering wheel 41 to be operated by the driver, an electronic power assist steering (EPAS) device 42 that assists the driver in a steering operation, and a pinion shaft 43 coupled to the EPAS device 42. The EPAS device 42 includes an electric motor 42a, and a deceleration device 42b that reduces the driving force from the electric motor 42a and transmits the force to the pinion shaft 43. The steering device 40 is a steering device of a steer-by-wire type, and actuates the EPAS device 42 in accordance with the operation amount of the steering wheel 41 detected by the steering angle sensor SW4, so as to rotate the pinion shaft 43, thereby controlling the front wheels 50. The pinion shaft 43 is coupled to the front wheels 50 through a rack bar, and the rotation of the pinion shaft 43 is transmitted to the front wheels via the rack bar. The EPAS device 42 is an example of a steering-related device.

The actuation of the steering device 40 is controlled by an EPAS microcomputer 500. For example, during the manual driving of the vehicle 1, the EPAS microcomputer 500 controls the operation amount of the electric motor 42a based on a detected value from the steering angle sensor SW4 and the like. In addition, during the assist driving or the autonomous driving of the vehicle 1, the EPAS microcomputer 500 basically calculates a controlled variable for each traveling device (EPAS device 42 in this case) and outputs a control signal to the corresponding traveling device, so as to achieve a target steering angle calculated by the arithmetic unit 110 described hereinafter. The EPAS microcomputer 500 is an example of the device controllers.

Although will be described later in detail, in the present embodiment, the powertrain ECU 200, the brake microcomputer 300, the DSC microcomputer 400, and the EPAS microcomputer 500 are capable of communicating with one another. In the following description, the powertrain ECU 200, the brake microcomputer 300, the DSC microcomputer 400, and the EPAS microcomputer 500 may be simply referred to as the device controllers.

As shown in FIG. 3, the cruise control device 100 of the present embodiment includes the arithmetic unit 110 that determines motions of the vehicle 1 to calculate a route to be traveled by the vehicle 1 and follow the route, so as to enable the assist driving and the autonomous driving. The respective “units” are configured as computing hardware of the arithmetic unit 110, which may be programmed with software code to perform described functions. The arithmetic unit 110 is a microprocessor configured by one or more chips, and includes a CPU, a memory, and the like. Note that FIG. 3 shows a configuration to exert functions according to the present embodiment (route generating function described later), and does not necessarily show all the functions implemented in the arithmetic unit 110.

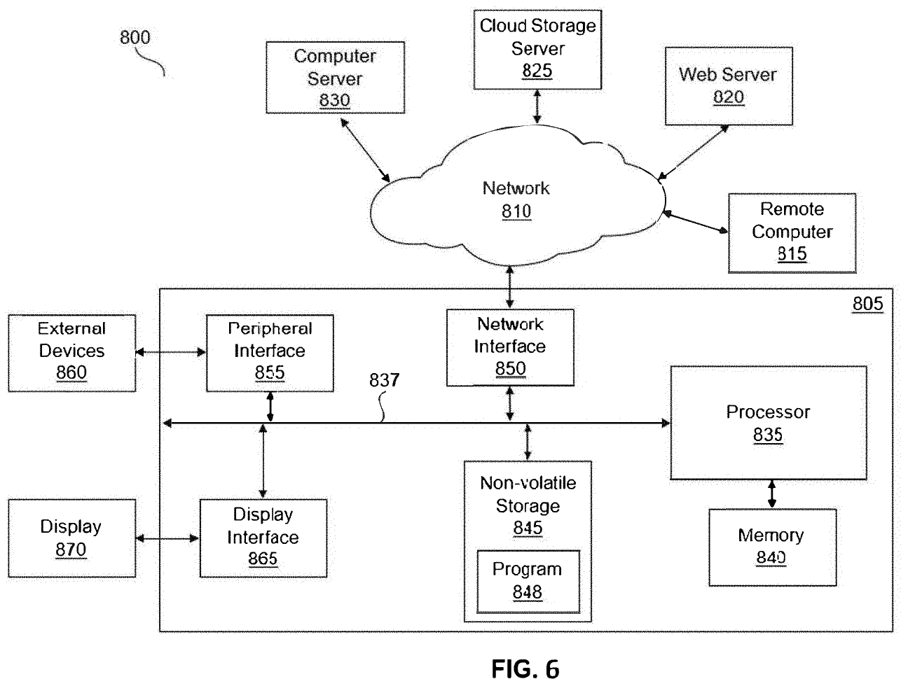

The cruise control device 100 is computer hardware (circuitry) that executes software, and specifically includes a processor including a CPU, and a non-transitory memory that stores executable code including a plurality of modules, for example, as will be discussed in more detail with respect to FIG. 6. The term “cruise control device” is used interchangeably herein with “cruise control circuitry”. It should be understood that regardless of whether the term “device” or “circuitry” is used, the device/circuitry can be dedicated circuitry, such as an application specific integrated circuit (ASIC), or programmable logic array (PLA), or processor circuitry that executes computer readable instructions to that cause the processor circuitry to perform certain functions by executing processing steps within the processing circuitry. The cruise control circuitry includes certain “units” which should be construed as structural circuit(s), whether application specific or programmable, that execute certain operations as part of the cruise control circuitry.

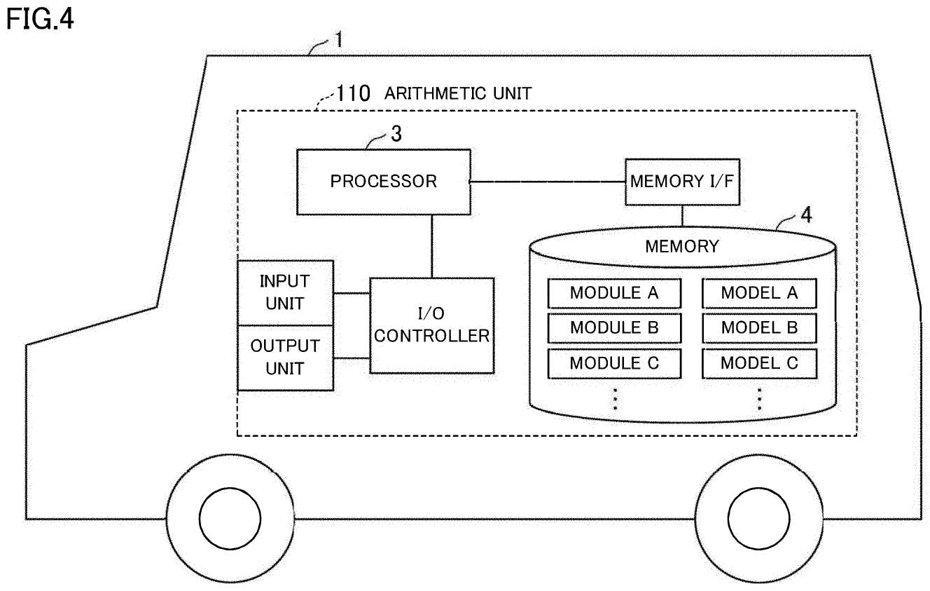

FIG. 4 is an exemplary configuration of the arithmetic unit 110. In the exemplary configuration of FIG. 4, the arithmetic unit 110 includes a processor 3 and a memory 4. The memory 4 stores modules which are each a software program executable by the processor 3. The function of each unit shown in FIG. 3 is achieved by the processor 3 executing the modules stored in the memory 4. In addition, the memory 4 stores data representing a model used in processing by each unit shown in FIG. 3. Note that a plurality of processors 3 and memories 4 may be provided.

As shown in FIG. 3, the arithmetic unit 110 determines a target motion of the vehicle 1 based on outputs from a plurality of sensors and the like, and controls actuation of the devices. The sensors and the like that output information to the arithmetic unit 110 include a plurality of cameras 70 that are provided to the body of the vehicle 1 and the like and take images of the environment outside the vehicle 1 (hereinafter, vehicle external environment); a plurality of radars 71 that are provided to the body of the vehicle 1 and the like and detect a target and the like outside the vehicle 1; a position sensor SW5 that detects the position of the vehicle 1 (vehicle position information) by using a Global Positioning System (GPS); a vehicle status sensor SW6 that acquires a status of the vehicle 1, which includes output from sensors that detect the behavior of the vehicle, such as a vehicle speed sensor, an acceleration sensor, and a yaw rate sensor; and an occupant status sensor SW7 that includes an in-vehicle camera and the like and acquires a status of an occupant on the vehicle 1. In addition, the arithmetic unit 110 receives communication information from another vehicle positioned around the subject vehicle or traffic information from a navigation system, which is received by a vehicle external communication unit 72.

The cameras 70 are arranged to image the surroundings of the vehicle 1 at 360° in the horizontal direction. Each camera 70 takes an optical image showing the vehicle external environment to generate image data. Each camera 70 then outputs the image data generated to the arithmetic unit 110. The cameras 70 are examples of an information acquisition unit that acquires information of the vehicle external environment.

The radars 71 are arranged so that the detection range covers 360° of the vehicle 1 in the horizontal direction, similarly to the cameras 70. The type of the radars 71 is not particularly limited. For example, a millimeter wave radar or an infrared radar may be adopted. The radars 71 are examples of an information acquisition unit that acquires information of the vehicle external environment.

During the assist driving or the autonomous driving, the arithmetic unit 110 sets a traveling route of the vehicle 1 and sets a target motion of the vehicle 1 so as to follow the traveling route of the vehicle 1. To set the target motion of the vehicle 1, the arithmetic unit 110 includes: a vehicle external environment recognition unit 111 that recognizes a vehicle external environment based on outputs from the cameras 70 and the like; a candidate route generation unit 112 that calculates one or more candidate routes that can be traveled by the vehicle 1, in accordance with the vehicle external environment recognized by the vehicle external environment recognition unit 111; a vehicle behavior estimation unit 113 that estimates the behavior of the vehicle 1 based on an output from the vehicle status sensor SW6; an occupant behavior estimation unit 114 that estimates the behavior of an occupant on the vehicle 1 based on an output from the occupant status sensor SW7; a route determination unit 115 that determines a route to be traveled by the vehicle 1; a vehicle motion determination unit 116 that determines the target motion of the vehicle 1 to follow the route set by the route determination unit 115; and a driving force calculation unit 117, a braking force calculation unit 118, and a steering angle calculation unit 119 that calculate target physical amounts (e.g., a driving force, a braking force, and a steering angle) to be generated by the traveling devices in order to achieve the target motion determined by the vehicle motion determination unit 116. The candidate route generation unit 112, the vehicle behavior estimation unit 113, the occupant behavior estimation unit 114, and the route determination unit 115 constitute a route setting unit that sets the route to be traveled by the vehicle 1, in accordance with the vehicle external environment recognized by the vehicle external environment recognition unit 111.

In addition, as safety functions, the arithmetic unit 110 includes a rule-based route generation unit 120 that recognizes an object outside the vehicle according to a predetermined rule and generates a traveling route that avoids the object, and a backup unit 130 that generates a traveling route that guides the vehicle 1 to a safety area such as a road shoulder.

Further, the arithmetic unit 110 includes a drive-assisting image generation unit 150 that generates an image to be displayed for driving assistance.

<Vehicle External Environment Recognition Unit>

The vehicle external environment recognition unit 111 (as further described in U.S. application Ser. No. 17/120,292 filed Dec. 14, 2020, and U.S. application Ser. No. 17/160,426 filed Jan. 28, 2021, the entire contents of each of which being incorporated herein by reference) receives outputs from the cameras 70 and the radars 71 mounted on the vehicle 1 and recognizes the vehicle external environment. The recognized vehicle external environment includes at least a road and an obstacle. Here, it is assumed that the vehicle external environment recognition unit 111 estimates the vehicle environment including the road and the obstacle by comparing the 3-dimensional information of the surroundings of the vehicle 1 with a vehicle external environment model, based on data from the cameras 70 and the radars 71. The vehicle external environment model is, for example, a learned model generated by deep learning, and allows recognition of a road, an obstacle, and the like with respect to 3-dimensional information of the surroundings of the vehicle.

For example, the vehicle external environment recognition unit 111 identifies a free space, that is, an area without an object, by processing images taken by the cameras 70. In this image processing, for example, a learned model generated by deep learning is used. Then, a 2-dimensional map representing the free space is generated. In addition, the vehicle external environment recognition unit 111 acquires information of a target around the vehicle 1 from outputs of the radars 71. This information is positioning information containing the position, the speed, and the like of the target. Then, the vehicle external environment recognition unit 111 combines the 2-dimensional map thus generated with the positioning information of the target to generate a 3-dimensional map representing the surroundings of the vehicle 1. This process uses information of the installation positions and the imaging directions of the cameras 70, and information of the installation positions and the transmission direction of the radars 71. The vehicle external environment recognition unit 111 then compares the 3-dimensional map with the vehicle external environment model to estimate the vehicle environment including the road and the obstacle. Note that the deep learning uses a multilayer neural network (DNN: Deep Neural Network). An example of the multilayer neural network is convolutional neural network (CNN).

<Candidate Route Generation Unit>

The candidate route generation unit 112 (an example of which is further described in more detail in U.S. application Ser. No. 17/161,691, filed 29 Jan. 2021, U.S. application Ser. No. 17/161,686, filed 29 Jan. 2021, and U.S. application Ser. No. 17/161,683, the entire contents of each of which being incorporated herein by reference) generates candidate routes that can be traveled by the vehicle 1, based on an output from the vehicle external environment recognition unit 111, an output from the position sensor SW5, and information transmitted from the vehicle external communication unit 73. For example, the candidate route generation unit 112 generates a traveling route that avoids the obstacle recognized by the vehicle external environment recognition unit 111, on the road recognized by the vehicle external environment recognition unit 111. The output from the vehicle external environment recognition unit 111 includes, for example, traveling road information related to a traveling road on which the vehicle 1 travels. The traveling road information includes information of the shape of the traveling road itself and information of an object on the traveling road. The information relating to the shape of the traveling road includes the shape of the traveling road (whether it is straight or curved, and the curvature), the width of the traveling road, the number of lanes, the width of each lane, and the like. The information related to the object includes a relative position and a relative speed of the object with respect to the vehicle, an attribute (type, moving direction) of the object, and the like. Examples of the object types include a vehicle, a pedestrian, a road, a section line, and the like.

Here, it is assumed that the candidate route generation unit 112 calculates a plurality of candidate routes by means of a state lattice method, and selects one or more candidate routes from among these candidate routes based on a route cost of each candidate route. However, the routes may be calculated by means of a different method.

The candidate route generation unit 112 sets a virtual grid area on the traveling road based on the traveling road information. The grid area has a plurality of grid points. With the grid points, a position on the traveling road is specified. The candidate route generation unit 112 sets a predetermined grid point as a target reach position. Then, a plurality of candidate routes are calculated by a route search involving a plurality of grid points in the grid area. In the state lattice method, a route branches from a certain grid point to random grid points ahead in the traveling direction of the vehicle. Therefore, each candidate route is set so as to sequentially pass a plurality of grid points. Each candidate route includes time information indicating a time of passing each grid point, speed information related to the speed, acceleration, and the like at each grid point, and information related to other vehicle motion, and the like.

The candidate route generation unit 112 selects one or more traveling routes from the plurality of candidate routes based on the route cost. The route cost herein includes, for example, the lane-centering degree, the acceleration of the vehicle, the steering angle, the possibility of collision, and the like. Note that, when the candidate route generation unit 112 selects a plurality of traveling routes, the route determination unit 115 selects one of the traveling routes.

<Vehicle Behavior Estimation Unit>

The vehicle status estimation unit 113 (as further described in PCT application WO2020184297A1 filed Mar. 3, 2020, the entire contents of which being incorporated herein by reference), measures a status of the vehicle, from the outputs of sensors which detect the behavior of the vehicle, such as a vehicle speed sensor, an acceleration sensor, and a yaw rate sensor. The vehicle behavior estimation unit 113 uses a six-degrees-of-freedom (6DoF) model of the vehicle indicating the behavior of the vehicle (as further described in more detail in U.S. application Ser. No. 17/159,175, filed Jan. 27, 2021, the entire contents of which being incorporated herein by reference).

Here, the 6DoF model of the vehicle is obtained by modeling acceleration along three axes, namely, in the “forward/backward (surge)”, “left/right (sway)”, and “up/down (heave)” directions of the traveling vehicle, and the angular velocity along the three axes, namely, “pitch”, “roll”, and “yaw”. That is, the 6DoF model of the vehicle is a numerical model not grasping the vehicle motion only on the plane (the forward/backward and left/right directions (i.e., the movement along the X-Y plane) and the yawing (along the Z-axis)) according to the classical vehicle motion engineering but reproducing the behavior of the vehicle using six axes in total. The vehicle motions along the six axes further include the pitching (along the Y-axis), rolling (along the X-axis), and the movement along the Z-axis (i.e., the up/down motion) of the vehicle body mounted on the four wheels with the suspension interposed therebetween.

The vehicle status estimation unit 113 applies the 6DoF model of the vehicle to the traveling route generated by the candidate route generation unit 112 to estimate the behavior of the vehicle 1 when following the traveling route.

<Occupant Behavior Estimation Unit>

The occupant behavior estimation unit 114 specifically estimates the driver's health conditions and emotions from a detection result from the occupant status sensor SW7. The health conditions include, for example, good health condition, slightly fatigue, poor health condition, decreased consciousness, and the like. The emotions include, for example, fun, normal, bored, annoyed, uncomfortable, and the like. Details of such estimation are disclosed in U.S. Pat. No. 10,576,989, which entire contents of which is hereby incorporated by reference.

For example, the occupant behavior estimation unit 114 extracts a face image of the driver from an image taken by a camera installed inside the vehicle cabin, and identifies the driver. The extracted face image and information of the identified driver are provided as inputs to a human model. The human model is, for example, a learned model generated by deep learning, and outputs the health condition and the emotion of each person who may be the driver of the vehicle 1, from the face image. The occupant behavior estimation unit 114 outputs the health condition and the emotion of the driver output by the human model.

In addition, in a case of adopting a bio-information sensor such as a skin temperature sensor, a heartbeat sensor, a blood flow sensor, a perspiration sensor, and the like as the occupant status sensor SW7 for acquiring information of the driver, the occupant behavior estimation unit 114 measures the bio-information of the driver from the output from the bio-information sensor. In this case, the human model uses the bio-information as the input, and outputs the health condition and the emotion of each person who may be the driver of the vehicle 1. The occupant behavior estimation unit 114 outputs the health condition and the emotion of the driver output by the human model.

In addition, as the human model, a model that estimates an emotion of a human in response to the behavior of the vehicle 1 may be used for each person who may be the driver of the vehicle 1. In this case, the model may be constructed by managing, in time sequence, the outputs of the vehicle behavior estimation unit 113, the bio-information of the driver, and the estimated emotional statuses. With this model, for example, it is possible to predict the relationship between changes in the driver's emotion (the degree of wakefulness) and the behavior of the vehicle.

In addition, the occupant behavior estimation unit 114 may include a human body model as the human model. The human body model specifies, for example, the weight of the head (e.g., 5 kg) and the strength of the muscles around the neck supporting against G-forces in the front, back, left, and right directions. The human body model outputs predicted physical and subjective properties of the occupant, when a motion (acceleration G-force or jerk) of the vehicle body is input. The physical property of the occupant is, for example, comfortable/moderate/uncomfortable, and the subjective property is, for example, unexpected/predictable. For example, a vehicle behavior that causes the head to lean backward even slightly is uncomfortable for an occupant. Therefore, a traveling route that causes the head to lean backward can be avoided by referring to the human body model. On the other hand, a vehicle behavior that causes the head of the occupant to lean forward in a bowing manner does not immediately lead to discomfort. This is because the occupant is easily able to resist such a force. Therefore, such a traveling route that causes the head to lean forward may be selected. Alternatively, a target motion can be dynamically determined by referring to the human body model, so that, for example, the head of the occupant does not swing or the head of the occupant stays active.

The occupant behavior estimation unit 114 applies a human model to the vehicle behavior estimated by the vehicle behavior estimation unit 113 to estimate a change in the health conditions or the emotion of the current driver with respect to the vehicle behavior.

<Route Determination Unit>

The route determination unit 115 determines the route to be traveled by the vehicle 1, based on an output from the occupant behavior estimation unit 114. If the number of routes generated by the candidate route generation unit 112 is one, the route determination unit 115 determines that route as the route to be traveled by the vehicle 1. If the candidate route generation unit 112 generates a plurality of routes, a route that an occupant (in particular, the driver) feels most comfortable with, that is, a route that the driver does not perceive as a redundant route, such as a route too cautiously avoiding an obstacle, is selected out of the plurality of candidate routes, in consideration of an output from the occupant behavior estimation unit 114.

<Rule-Based Route Generation Unit>

The rule-based route generation unit 120 recognizes an object outside the vehicle in accordance with a predetermined rule based on outputs from the cameras 70 and radars 71, without using deep learning, and generates a traveling route that avoids such an object. Similarly to the candidate route generation unit 112, it is assumed that the rule-based route generation unit 120 also calculates a plurality of candidate routes by means of the state lattice method, and selects one or more candidate routes from among these candidate routes based on a route cost of each candidate route. Further explanation of how a route cost may be determined is described in U.S. patent application Ser. No. 16/739,144, filed on Jan. 10, 2020, the entire contents of which is incorporated herein by reference. In the rule-based route generation unit 120, the route cost is calculated based on, for example, a rule of keeping away from a several meter range from the object. Other techniques may be used for calculation of the route also in this rule-based route generation unit 120.

Information of a route generated by the rule-based route generation unit 120 is input to the vehicle motion determination unit 116.

<Backup Unit>

The backup unit 130 generates a traveling route that guides the vehicle 1 to a safety area such as the road shoulder based on outputs from the cameras 70 and radars 71, in an occasion of failure of a sensor and the like or when the occupant is not feeling well. For example, from the information given by the position sensor SW5, the backup unit 130 sets a safety area in which the vehicle 1 can be stopped in case of emergency, and generates a traveling route to reach the safety area. Similarly to the candidate route generation unit 112, it is assumed that the backup unit 130 also calculates a plurality of candidate routes by means of the state lattice method, and selects one or more candidate routes from among these candidate routes based on a route cost of each candidate route. Another technique may be used for calculation of the route also in this backup unit 130.

Information of a route generated by the backup unit 130 is input to the vehicle motion determination unit 116.

<Vehicle Motion Determination Unit>

The vehicle motion determination unit 116 (as further described in more detail in U.S. application Ser. No. 17/159,178, filed Jan. 27, 2021, the entire contents of which being incorporated herein by reference), determines a target motion on a traveling route determined by the route determination unit 115. The target motion means steering and acceleration/deceleration to follow the traveling route. In addition, with reference to the 6DoF model of the vehicle, the vehicle motion determination unit 116 calculates the motion of the vehicle on the traveling route selected by the route determination unit 115.

The vehicle motion determination unit 116 determines the target motion to follow the traveling route generated by the rule-based route generation unit 120.

The vehicle motion determination unit 116 determines the target motion to follow the traveling route generated by the backup unit 130.

When the traveling route determined by the route determination unit 115 significantly deviates from a traveling route generated by the rule-based route generation unit 120, the vehicle motion determination unit 116 selects the traveling route generated by the rule-based route generation unit 120 as the route to be traveled by the vehicle 1.

In an occasion of failure of sensors and the like (in particular, cameras 70 or radars 71) or in a case where the occupant is not feeling well, the vehicle motion determination unit 116 selects the traveling route generated by the backup unit 130 as the route to be traveled by the vehicle 1.

<Physical Amount Calculation Unit>

A physical amount calculation unit includes a driving force calculation unit 117, a braking force calculation unit 118, and a steering angle calculation unit 119. To achieve the target motion, the driving force calculation unit 117 calculates a target driving force to be generated by the powertrain devices (the engine 10, the transmission 20). To achieve the target motion, the braking force calculation unit 118 calculates a target braking force to be generated by the brake device 30. To achieve the target motion, the steering angle calculation unit 119 calculates a target steering angle to be generated by the steering device 40.

<Peripheral Device Operation Setting Unit>

A peripheral device operation setting unit 140 sets operations of body-related devices of the vehicle 1, such as lamps and doors, based on outputs from the vehicle motion determination unit 116. The peripheral device operation setting unit 140 determines, for example, the directions of lamps, while the vehicle 1 follows the traveling route determined by the route determination unit 115. In addition, for example, at a time of guiding the vehicle 1 to the safety area set by the backup unit 130, the peripheral device operation setting unit 140 sets operations so that the hazard lamp is turned on and the doors are unlocked after the vehicle reaches the safety area.

<Drive-Assisting Image Generation Unit>

In the present embodiment, the arithmetic unit 110 includes the drive-assisting image generation unit 150 that generates an image to be displayed on a vehicle-interior display 700 and the like for driving assistance. As described above, in the arithmetic unit 110, the vehicle external environment recognition unit 111 receives outputs from cameras 70 that take images of the vehicle external environment to recognize the vehicle external environment, and estimates the road and an obstacle through prediction using a model. The drive-assisting image generation unit 150 receives the outputs from the cameras 70 and information on vehicle external environment from the vehicle external environment recognition unit 111 to generate an image for driving assistance. For example, the drive-assisting image generation unit 150 generates an image showing a region around its vehicle including the subject vehicle itself by combining images taken by the cameras 70, receives information on an obstacle estimated by the vehicle external environment recognition unit 111, and superimpose an image emphasizing the obstacle on the generated image. The captured images can be said images taken, and encompass dynamic images. The arithmetic unit 110 then transmits, to the vehicle-interior display 700, image signals, such as RGB signals, representing the image generated by the drive-assisting image generation unit 150. The amount of image signals displayed considerably less than the output from the cameras 70, e.g., a subset of the image signals most useful for aiding the driver, such as information regarding obstacles in the travel path. In particular, while the drive-assisting image generation unit 150 may receive all of the image signals from the cameras 70, the drive-assisting image generation unit 150 also receives information regarding the external environment, so that only image signals related to the surrounding external environment including obstacles may be used to generate the image. The vehicle-interior display 700 displays an image for driving assistance based on the image signals having received from the arithmetic unit 110.

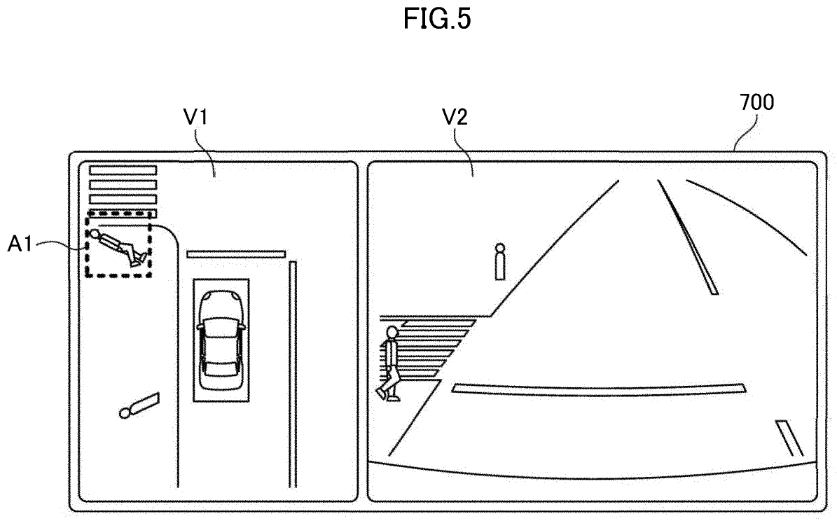

FIG. 5 shows an example of the image to be displayed on the vehicle-interior display 700. In the example of FIG. 5, the vehicle-interior display 700 displays, side-by-side, a synthesized image V1 showing a plan view of the vehicle and its surroundings and a camera image V2 of a camera outputting an image in front of the vehicle, e.g., a camera installed at a front portion of the vehicle body. The synthesized image V1 is generated by converting coordinates of image data sets from a plurality of cameras installed around the vehicle and combining those image data sets. In the example shown in FIG. 5, the vehicle external environment recognition unit 111 estimates a person ahead on the left side of the vehicle to be an obstacle, and an indication A1 emphasizing the person is superimposed on the synthesized image V1.

As described, with the drive-assisting image generation unit 150 in the arithmetic unit 110, it is possible to display an image that assists the driver without providing a large-scale HMI (Human Machine Interface) unit, in addition to the arithmetic unit 110. That is, even if an HMI unit is provided to the vehicle, that HMI unit does not have to generate an image for driving assistance from an enormous amount of raw data such as camera images. In addition, since outputs from the cameras 70 whose data volume is large simply has to be transmitted to the arithmetic unit 110, the configuration for data transmission in the vehicle is simplified.

<Output Destination of Arithmetic Unit>

An arithmetic result of the arithmetic unit 110 is output to the powertrain ECU 200, the brake microcomputer 300, the EPAS microcomputer 500, and the body-related microcomputer 600. Specifically, information related to the target driving force calculated by the driving force calculation unit 117 is input to the powertrain ECU 200. Information related to the target braking force calculated by the braking force calculation unit 118 is input to the brake microcomputer 300. Information related to the target steering angle calculated by the steering angle calculation unit 119 is input to the EPAS microcomputer 500. Information related to the operations of the body-related devices set by the peripheral device operation setting unit 140 is input to the body-related microcomputer 600.

The arithmetic unit 100 then transmits, to the vehicle-interior display 700, image signals, such as RGB signals, representing the image generated by the drive-assisting image generation unit 150.

As described hereinabove, the powertrain ECU 200 basically calculates fuel injection timing for the injector 12 and ignition timing for the spark plug 13 so as to achieve the target driving force, and outputs control signals to these relevant traveling devices. The brake microcomputer 300 basically calculates a controlled variable of the brake actuator 33 so as to achieve the target driving force, and outputs a control signal to the brake actuator 33. The EPAS microcomputer 500 basically calculates an electric current amount to be supplied to the EPAS device 42 so as to achieve the target steering angle, and outputs a control signal to the EPAS device 42.

As described hereinabove, in the present embodiment, the arithmetic unit 110 only calculates the target physical amount to be output from each traveling device, and the controlled variables of traveling devices are calculated by the device controllers 200 to 500. This reduces the amount of calculation by the arithmetic unit 110, and improves the speed of calculation by the arithmetic unit 110. In addition, since each of the device controllers 200 to 500 simply has to calculate the actual controlled variables and output control signals to the traveling devices (injector 12 and the like), the processing speed is fast. As a result, the responsiveness of the traveling devices to the vehicle external environment can be improved.

In addition, by having the device controllers 200 to 500 calculate the controlled variables, the calculation speed of the arithmetic unit 110 can be slower than those of the device controllers 200 to 500, because the arithmetic unit 110 only needs to roughly calculate physical amounts. Thus, the accuracy of calculation by the arithmetic unit 110 is improved.

Thus, the present embodiment includes: an arithmetic unit 110, and device controllers 200 to 500 that control actuation of one or more traveling devices (injector 12 and the like) mounted in a vehicle 1, based on an arithmetic result from the arithmetic unit 110. The arithmetic unit 110 includes: a vehicle external environment recognition unit 111 that recognizes a vehicle external environment based on outputs from a camera 70 and a radar 71 which acquires information of the vehicle external environment; a route setting unit (candidate route generation unit 112 and the like) that sets a route to be traveled by the vehicle 1, in accordance with the vehicle external environment recognized by the vehicle external environment recognition unit 111; a vehicle motion determination unit 116 that determines the target motion of the vehicle 1 to follow the route set by the route setting unit; and a drive-assisting image generation unit 150 that generates an image to be displayed for driving assistance, by using images taken by the cameras 70 and information on the vehicle external environment recognized by the vehicle external environment recognition unit 111. With this configuration, the HMI unit itself does not have to generate an image for driving assistance by taking in an enormous amount of raw data such as camera images. Therefore, it is possible to display an image that assists the driver without providing a large-scale HMI unit, in addition to the arithmetic unit 110. Even if an HMI unit is provided to the vehicle, that HMI unit does not have to have a function to generate an image for driving assistance from an enormous amount of raw data such as camera images. In addition, since outputs from the cameras whose data volume is large simply has to be transmitted to the arithmetic unit, the configuration for data transmission in the vehicle is simplified.

In addition, the arithmetic unit 110 includes physical amount calculation units 117 to 119 that calculate target physical amounts to be generated by the traveling devices for achieving a target motion determined by the vehicle motion determination unit 116. The device controllers 200 to 500 calculate controlled variables of the traveling devices to achieve the target physical amounts calculated by the physical amount calculation units 117 to 119, and outputs control signals to the traveling devices. As described hereinabove, the arithmetic unit 110 only calculates the physical amounts that should be achieved, and the actual controlled variables of the traveling devices are calculated by the device controllers 200 to 500. This reduces the amount of calculation by the arithmetic unit 110, and improves the speed of calculation by the arithmetic unit 110. In addition, since the device controllers 200 to 500 simply have to calculate the actual controlled variables and output control signals to the associated traveling devices, the processing speed is fast. As a result, the responsiveness of the traveling devices to the vehicle external environment can be improved.

In particular, in the present embodiment, the vehicle external environment recognition unit 111 uses deep learning to recognize the vehicle external environment, which increases the amount of calculation particularly in the arithmetic unit 110. By having the controlled variables of the traveling devices calculated by the device controllers 200 to 500, which are separate from the arithmetic unit 110, it is possible to more appropriately exert the effect of further improving the responsiveness of the traveling devices with respect to the vehicle external environment.

<Other Controls>

The driving force calculation unit 117, the braking force calculation unit 118, and the steering angle calculation unit 119 may modify the target driving force in accordance with the status of the driver of the vehicle 1, during the assist driving of the vehicle 1. For example, when the driver enjoys driving (when the emotion of the driver is “Fun”), the target driving force and the like may be reduced to make driving as close as possible to manual driving. On the other hand, when the driver is not feeling well, the target driving force and the like may be increased to make the driving as close as possible to the autonomous driving.

### Other Embodiments

The present disclosure is not limited to the embodiment described above. Any change can be made within the scope of the claims as appropriate.

For example, in the above-described embodiment, the route determination unit 115 determines the route to be traveled by the vehicle 1. However, the present disclosure is not limited to this, and the route determination unit 115 may be omitted. In this case, the vehicle motion determination unit 116 may determine the route to be traveled by the vehicle 1. That is, the vehicle motion determination unit 116 may serve as a part of the route setting unit as well as a target motion determination unit.

In addition, in the above-described embodiment, the driving force calculation unit 117, the braking force calculation unit 118, and the steering angle calculation unit 119 calculate target physical amounts such as a target driving force. However, the present disclosure is not limited to this. The driving force calculation unit 117, the braking force calculation unit 118, and the steering angle calculation unit 119 may be omitted, and the target physical amounts may be calculated by the vehicle motion determination unit 116. That is, the vehicle motion determination unit 116 may serve as the target motion determination unit as well as a physical amount calculation unit.

FIG. 6 illustrates a block diagram of a computer that may implement the various embodiments described herein.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 6 is a functional block diagram illustrating a networked system 800 of one or more networked computers and servers. In an embodiment, the hardware and software environment illustrated in FIG. 6 may provide an exemplary platform for implementation of the software and/or methods according to the present disclosure.

Referring to FIG. 6, a networked system 800 may include, but is not limited to, computer 805, network 810, remote computer 815, web server 820, cloud storage server 825 and computer server 830. In some embodiments, multiple instances of one or more of the functional blocks illustrated in FIG. 6 may be employed.

Additional detail of computer 805 is shown in FIG. 6. The functional blocks illustrated within computer 805 are provided only to establish exemplary functionality and are not intended to be exhaustive. And while details are not provided for remote computer 815, web server 820, cloud storage server 825 and computer server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm. Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and computer server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

In a non-limiting example, a process is described about how a learned model is trained, according to the present teachings. The example will be in the context of a vehicle external environment estimation circuitry (e.g., a trained model saved in a memory and applied by a computer). However, other aspects of the trained model for object detection/avoidance, route generation, controlling steering, braking, etc., are implemented via similar processes to acquire the learned models used in the components of the arithmetic unit 110. Hereinafter, as part of a process for determining how a candidate route generation unit 112 calculates a route in the presence of an obstacle (a person). In this example, the obstacle is a person that has been captured by a forward looking camera from the vehicle 1. The model is hosted in a single information processing unit (or single information processing circuitry).

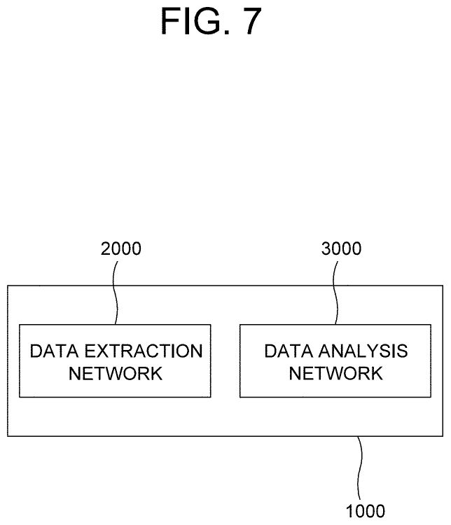

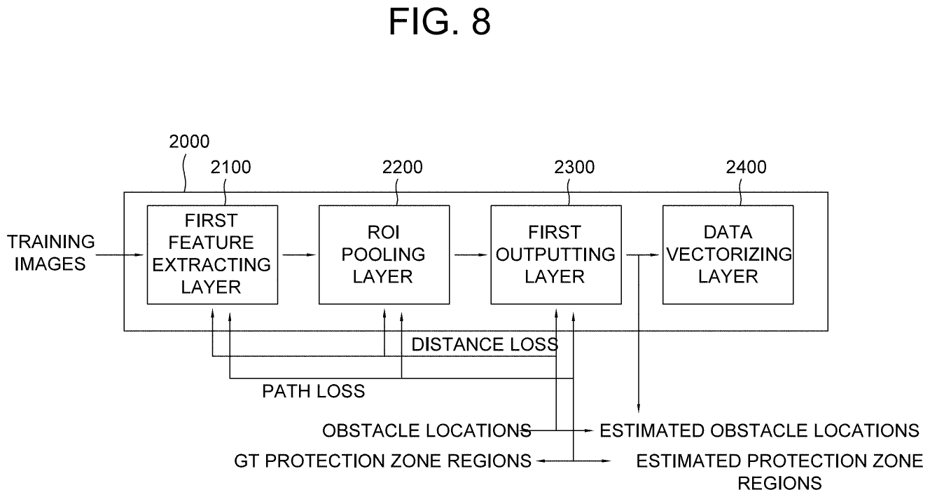

First, by referring to FIG. 7, a configuration of the computing device 1000 will be explained. The computing device 1000 may include a data extraction network 2000 and a data analysis network 3000. Further, to be illustrated in FIG. 8, the data extraction network 2000 may include at least one first feature extracting layer 2100, at least one Region-Of-Interest (ROI) pooling layer 2200, at least one first outputting layer 2300 and at least one data vectorizing layer 2400. And, the data analysis network 3000 may include at least one second feature extracting layer 3100 and at least one second outputting layer 3200.

Below, an aspect of calculating a route within a free space that surrounds the obstacle will be explained in the context of training a learned model. Moreover, the specific aspect is to learn a model to detect obstacles. To begin with, a first aspect of the learning of a learned model according to the present disclosure will be presented.

First, the computing device 1000 may acquire at least one subject image that includes a free space about the vehicle 1. By referring to FIG. 5, the subject image may correspond to a scene of a highway, photographed from a vehicle 1.

After the subject image is acquired, in order to generate a source vector to be inputted to the data analysis network 3000, the computing device 1000 may instruct the data extraction network 2000 to generate the source vector including (i) an apparent distance, which is a distance from a front of vehicle 1 to an obstacle, and (ii) an apparent size, which is a size of the free space

In order to generate the source vector, the computing device 1000 may instruct at least part of the data extraction network 2000 to detect the obstacle and free space.

Specifically, the computing device 1000 may instruct the first feature extracting layer 2100 to apply at least one first convolutional operation to the subject image, to thereby generate at least one subject feature map. Thereafter, the computing device 1000 may instruct the ROI pooling layer 2200 to generate one or more ROI-Pooled feature maps by pooling regions on the subject feature map, corresponding to ROIs on the subject image which have been acquired from a Region Proposal Network (RPN) interworking with the data extraction network 2000. And, the computing device 1000 may instruct the first outputting layer 2300 to generate at least one estimated obstacle location and one estimated free space. That is, the first outputting layer 2300 may perform a classification and a regression on the subject image, by applying at least one first Fully-Connected (FC) operation to the ROI-Pooled feature maps, to generate each of the estimated obstacle location and free space, including information on coordinates of each of bounding boxes. Herein, the bounding boxes may include the obstacle and a free space around the obstacle.

After such detecting processes are completed, by using the estimated obstacle location and the estimated free space, the computing device 1000 may instruct the data vectorizing layer 2400 to subtract a y-axis coordinate (distance in this case) of an upper bound of the obstacle from a y-axis coordinate of the closer boundary of the free space to generate the apparent distance to the vehicle 1, and multiply a distance of the free space region and a horizontal width of the free space region to generate the apparent size of the free space.

After the apparent distance and the apparent size are acquired, the computing device 1000 may instruct the data vectorizing layer 2400 to generate at least one source vector including the apparent distance and the apparent size as its at least part of components.

Then, the computing device 1000 may instruct the data analysis network 3000 to calculate an estimated actual free space by using the source vector. Herein, the second feature extracting layer 3100 of the data analysis network 3000 may apply second convolutional operation to the source vector to generate at least one source feature map, and the second outputting layer 3200 of the data analysis network 3000 may perform a regression, by applying at least one FC operation to the source feature map, to thereby calculate the estimated free space.

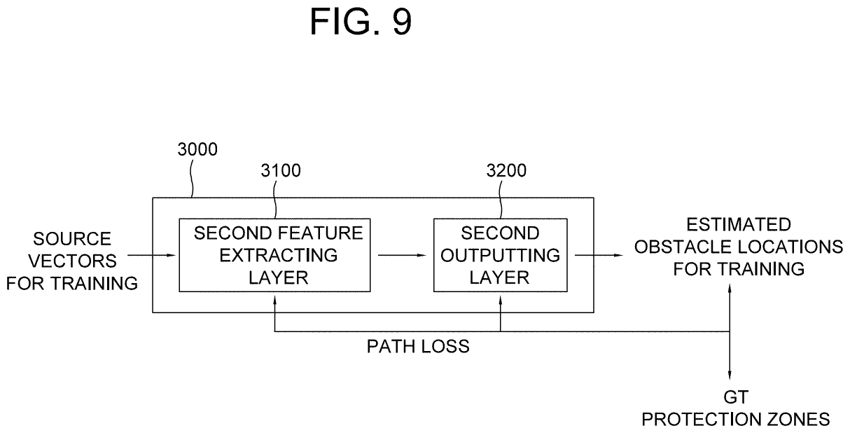

As shown above, the computing device 1000 may include two neural networks, i.e., the data extraction network 2000 and the data analysis network 3000. The two neural networks should be trained to perform the processes properly, and thus below it is described how to train the two neural networks by referring to FIG. 8 and FIG. 9.

First, by referring to FIG. 8, the data extraction network 2000 may have been trained by using (i) a plurality of training images corresponding to scenes of subject roadway conditions for training, photographed from fronts of the subject vehicles for training, including images of their corresponding projected free spaces (free spaces superimposed around an obstacle) for training and images of their corresponding grounds for training, and (ii) a plurality of their corresponding to actual observed obstacle locations and actual observed free space regions. The free space regions do not occur naturally, but are previously superimposed about the vehicle 1 via another process, perhaps a bounding box by the camera. More specifically, the data extraction network 2000 may have applied aforementioned operations to the training images, and have generated their corresponding estimated obstacle location and estimated free space regions. Then, (i) each of obstacle pairs of each of the estimated obstacle locations and each of their corresponding actual observed obstacle locations and (ii) each of obstacle pairs of each of the estimated free space locations associated with the obstacles and each of the actual observed free space locations may have been referred to, in order to generate at least one vehicle path loss and at least one distance, by using any of loss generating algorithms, e.g., a smooth-L1 loss algorithm and a cross-entropy loss algorithm. Thereafter, by referring to the distance loss and the path loss, backpropagation may have been performed to learn at least part of parameters of the data extraction network 2000. Parameters of the RPN can be trained also, but a usage of the RPN is a well-known prior art, thus further explanation is omitted.

Herein, the data vectorizing layer 2400 may have been implemented by using a rule-based algorithm, not a neural network algorithm. In this case, the data vectorizing layer 2400 may not need to be trained, and may just be able to perform properly by using its settings inputted by a manager.

As an example, the first feature extracting layer 2100, the ROI pooling layer 2200 and the first outputting layer 2300 may be acquired by applying a transfer learning, which is a well-known prior art, to an existing object detection network such as VGG or ResNet, etc.

Second, by referring to FIG. 9, the data analysis network 3000 may have been trained by using (i) a plurality of source vectors for training, including apparent distances for training and apparent sizes for training as their components, and (ii) a plurality of their corresponding actual observed free space regions. More specifically, the data analysis network 3000 may have applied aforementioned operations to the source vectors for training, to thereby calculate their corresponding estimated free space regions for training. Then each of distance pairs of each of the estimated free space regions and each of their corresponding actual observed free space regions may have been referred to, in order to generate at least one distance loss, by using said any of loss algorithms. Thereafter, by referring to the distance loss, backpropagation can be performed to learn at least part of parameters of the data analysis network 3000.

After performing such training processes, the computing device 1000 can properly calculate the estimated free space by using the subject image including the scene photographed from the front of the subject roadway.

Hereafter, another embodiment will be presented. A second embodiment is similar to the first embodiment, but different from the first embodiment in that the source vector thereof further includes a tilt angle, which is an angle between an optical axis of a camera which has been used for photographing the subject image (e.g., the subject obstacle) and a distance to the obstacle. Also, in order to calculate the tilt angle to be included in the source vector, the data extraction network of the second embodiment may be slightly different from that of the first one. In order to use the second embodiment, it should be assumed that information on a principal point and focal lengths of the camera are provided.

Specifically, in the second embodiment, the data extraction network 2000 may have been trained to further detect lines of a road in the subject image, to thereby detect at least one vanishing point of the subject image. Herein, the lines of the road may denote lines representing boundaries of the road located on the obstacle in the subject image, and the vanishing point may denote where extended lines generated by extending the lines of the road, which are parallel in the real world, are gathered. As an example, through processes performed by the first feature extracting layer 2100, the ROI pooling layer 220 and the first outputting layer 2300, the lines of the road may be detected.

After the lines of the road are detected, the data vectorizing layer 240 may find at least one point where the most extended lines are gathered, and determine it as the vanishing point. Thereafter, the data vectorizing layer 2400 may calculate the tilt angle by referring to information on the vanishing point, the principal point and the focal lengths of the camera by using a following formula:

$${θ}_{tilt} = a tan 2 ( v y - cy , fy )$$

In the formula, vy may denote a y-axis (distance direction) coordinate of the vanishing point, cy may denote a y-axis coordinate of the principal point, and fy may denote a y-axis focal length. Using such formula to calculate the tilt angle is a well-known prior art, thus more specific explanation is omitted.

After the tilt angle is calculated, the data vectorizing layer 2400 may set the tilt angle as a component of the source vector, and the data analysis network 3000 may use such source vector to calculate the estimated free space. In this case, the data analysis network 3000 may have been trained by using the source vectors for training additionally including tilt angles for training.

For a third embodiment which is mostly similar to the first one, some information acquired from a subject obstacle database storing information on subject obstacles, including the subject obstacle, can be used for generating the source vector. That is, the computing device 1000 may acquire structure information on a structure of the subject vehicle, e.g., 4 doors, vehicle base length of a certain number of feet, from the subject vehicle DB. Or, the computing device 1000 may acquire topography information on a topography of a region around the subject vehicle, e.g., hill, flat, bridge, etc., from location information for the particular roadway. Herein, at least one of the structure information and the topography information can be added to the source vector by the data vectorizing layer 2400, and the data analysis network 3000, which has been trained by using the source vectors for training additionally including corresponding information, i.e., at least one of the structure information and the topography information, may use such source vector to calculate the estimated free space.

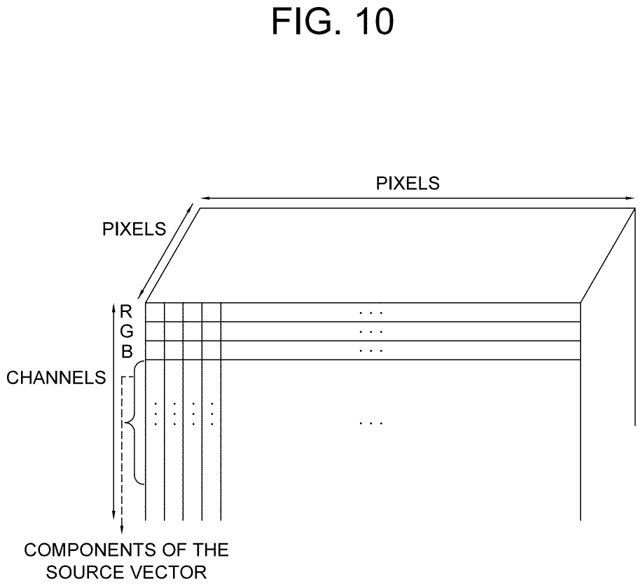

As a fourth embodiment, the source vector, generated by using any of the first to the third embodiments, can be concatenated channel-wise to the subject image or its corresponding subject segmented feature map, which has been generated by applying an image segmentation operation thereto, to thereby generate a concatenated source feature map, and the data analysis network 3000 may use the concatenated source feature map to calculate the estimated free space. An example configuration of the concatenated source feature map may be shown in FIG. 10. In this case, the data analysis network 3000 may have been trained by using a plurality of concatenated source feature maps for training including the source vectors for training, other than using only the source vectors for training. By using the fourth embodiment, much more information can be inputted to processes of calculating the estimated free space, thus it can be more accurate. Herein, if the subject image is used directly for generating the concatenated source feature map, it may require too much computing resources, thus the subject segmented feature map may be used for reducing a usage of the computing resources.

Descriptions above are explained under an assumption that the subject image has been photographed from the back of the subject vehicle, however, embodiments stated above may be adjusted to be applied to the subject image photographed from other sides of the subject vehicle. And such adjustment will be easy for a person in the art, referring to the descriptions.

The above described deep learning process for defining free spaces around obstacles, may be used in a similar fashion for developing other learned models, such as for estimating an internal or external environment within the vehicle, calculating a route etc. as discussed herein.

The embodiment described above is merely an example in nature, and the scope of the present disclosure should not be interpreted in a limited manner. The scope of the present disclosure is defined by the appended claims, and all variations and changes belonging to a range equivalent to the range of the claims are within the scope of the present disclosure.

### INDUSTRIAL APPLICABILITY

The technology disclosed herein is usable as a vehicle cruise control device to control traveling of the vehicle.

### DESCRIPTION OF REFERENCE CHARACTERS

1 Vehicle
12 Injector (Traveling Device)
13 Spark Plug (Traveling Device)
16 Valve Train Mechanism (Traveling Device)
20 Transmission (Traveling Device)
33 Brake Actuator (Traveling Device)
42 EPAS Device (Traveling Device)
100 Vehicle Cruise Control Device
110 Arithmetic Unit
111 Vehicle External Environment Recognition Unit
112 Candidate Route Generation Unit (Route Setting Unit)
113 Vehicle Behavior Estimation Unit (Route Setting Unit)
114 Occupant Behavior Estimation Unit (Route Setting Unit)
115 Route Determination Unit (Route Setting Unit)
116 Vehicle Motion Determination Unit (Target Motion Determination unit)
117 Driving Force Calculation Unit (Physical Amount Calculation Unit)
118 Braking Force Calculation Unit (Physical Amount Calculation Unit)
119 Steering Angle Calculation Unit (Physical Amount Calculation Unit)
150 Drive-Assisting Image Generation Unit
200 Powertrain ECU (Device Controller)
300 Brake Microcomputer (Device Controller)
400 DSC Microcomputer (Device Controller)
500 EPAS Microcomputer (Device Controller)

1. A vehicle cruise control device that controls traveling of a vehicle, the vehicle cruise control device comprising:
an arithmetic circuitry configured to:
recognize a vehicle external environment based on an output from a camera that supplies an image of the vehicle external environment;
set a route to be traveled by the vehicle, in accordance with the vehicle external environment recognized;
determine a target motion of the vehicle to follow the route set; and
generate an image to be displayed for driving assistance, from the image supplied by the camera and information on the vehicle external environment recognized; and
control circuitry configured to control actuation of one or more traveling devices mounted in the vehicle, based on the target motion determined.

2. The vehicle cruise control device of claim 1, wherein
the arithmetic circuitry is further configured to:
receive information on an obstacle in the vehicle external environment recognized,
generate an image showing a region around the vehicle including the vehicle by combining images supplied by the camera, and
superimpose an indication that emphasizes the obstacle on the image generated to be displayed for driving assistance.

3. The vehicle cruise control device of claim 2, wherein
the arithmetic circuitry is further configured to:
calculate target physical amounts to be generated by the one or more traveling devices, in order to achieve the target motion determined,
control variables of the one or more traveling devices to achieve the target physical amounts calculated and
output control signals to the one or more traveling devices.

4. The vehicle cruise control device of claim 3, wherein
the arithmetic circuitry is configured to recognize the vehicle external environment by means of deep learning.

5. The vehicle cruise control device of claim 2, wherein
the arithmetic circuitry is configured to recognize the vehicle external environment by means of deep learning.

6. The vehicle cruise control device of claim 2, wherein
the arithmetic circuitry is further configured to convert coordinates of image data from a plurality of cameras around the vehicle and combine the image data to generate the image showing the region around the vehicle including the vehicle.

7. The vehicle cruise control device of claim 6, wherein
the image showing the region around the vehicle including the vehicle is in plan view.

8. The vehicle cruise control device of claim 2, wherein
the arithmetic circuitry is further configured to output an image from a forward facing camera and the image showing the region around the vehicle including the vehicle to be displayed for driving assistance.

9. The vehicle cruise control device of claim 1, wherein
the arithmetic circuitry is configured to recognize the vehicle external environment by means of deep learning.

10. The vehicle cruise control device of claim 1, wherein
the arithmetic circuitry is further configured to synthesize image data from a plurality of cameras around the vehicle and the vehicle external environment recognized to form a synthesized image to be displayed for driving assistance.

11. The vehicle cruise control device of claim 10, wherein
the synthesized image is a plan view of the vehicle and the vehicle external environment.

12. A vehicle travel control method, comprising:
recognizing a vehicle external environment based on an output from a camera that supplies an image of the vehicle external environment;
setting a route to be traveled by the vehicle, in accordance with the vehicle external environment recognized;
determining a target motion of the vehicle to follow the route set;
generating an image to be displayed for driving assistance, from the image supplied by the camera and information on the vehicle external environment recognized; and
controlling actuation of one or more traveling devices mounted in the vehicle, based on the target motion determined.

13. The vehicle travel control method of claim 12, wherein generating an image to be displayed for driving assistance includes:
receiving information on an obstacle in the vehicle external environment recognized,
generating an image showing a region around the vehicle including the vehicle by combining images supplied by the camera, and
superimposing an indication that emphasizes the obstacle on the image generated to be displayed for driving assistance.

14. A non-transitory computer readable medium having instructions stored therein that once executed by a processor cause the processor to execute a vehicle travel control method, the method comprising:
recognizing a vehicle external environment based on an output from a camera that supplies an image of the vehicle external environment;
setting a route to be traveled by the vehicle, in accordance with the vehicle external environment recognized;
determining a target motion of the vehicle to follow the route set;
generating an image to be displayed for driving assistance, from the image supplied by the camera and information on the vehicle external environment recognized; and
controlling actuation of one or more traveling devices mounted in the vehicle, based on the target motion determined.

15. The non-transitory computer readable medium of claim 14, wherein generating an image to be displayed for driving assistance includes:
receiving information on an obstacle in the vehicle external environment recognized,
generating an image showing a region around the vehicle including the vehicle by combining images supplied by the camera, and
superimposing an indication that emphasizes the obstacle on the image generated to be displayed for driving assistance.
